(19) United States
(12) Patent Application Publication
(10) Pub. No.: US 2010/0022677 A1
(43) Pub. Date: Jan. 28, 2010

(54) REDUCTION OF FREE RADICALS IN CROSSLINKED POLYETHYLENE BY INFRARED HEATING

(75) Inventors: Donald Yakimicki, Plymouth, IN (US); Brian H. Thomas, Columbia City, IN (US); Alicia Rufner, Columbia City, IN (US); Dirk Pletcher, Walkerton, IN (US); Hallie E. Brinkerhuff, Winona Lake, IN (US); Michael E. Hawkins, Columbia City, IN (US)

Correspondence Address: ZIMMER TECHNOLOGY - BAKER & DANIELS, 111 EAST WAYNE STREET, SUITE 800, FORT WAYNE, IN, 46802, US

(73) Assignee: ZIMMER, INC., Warsaw, IN (US)

(21) Appl. No.: 12/179,170

(22) Filed: Jul. 24, 2008

(51) Int. Cl. C08J 3/28; C08F 110/02

(52) U.S. Cl. 522/161; 525/333.7

(57) ABSTRACT

UHMWPE is exposed to crosslinking radiation and than heated utilizing infrared radiation. In one exemplary embodiment, the infrared radiation is provided by an infrared heater having a tungsten heating element with a quartz tube. In this embodiment, the infrared radiation may have the wavelength from about 1.0 micron to about 1.5 microns. In another exemplary embodiment, the UHMWPE is compression molded into bars prior to exposure to the crosslinking radiation.

### BACKGROUND

1. Field of the Invention

The present invention relates to crosslinked ultra-high molecular weight polyethylene and, particularly, to annealed, crosslinked ultra-high molecular weight polyethylene.

2. Description of the Related Art

Ultra-high molecular weight polyethylene (UHMWPE) is commonly utilized in medical device applications. In order to beneficially alter the material properties of UHMWPE and decrease its wear rate, UHMWPE may be crosslinked. For example, UHMWPE may be subjected to electron beam or gamma radiation, causing chain scission of the individual polyethylene molecules as well as the breaking of C—H bonds to form free radicals on the polymer chains. While free radicals on adjacent polymer chains may bond to one another to form crosslinked UHMWPE, some free radicals may remain in the UHMWPE following irradiation, which could potentially combine with oxygen and result in oxidation of the UHMWPE. Oxidation may detrimentally affect the wear properties of the UHMWPE and may also increase its wear rate. As a result, the oxidized layer of the UHMWPE, which may be a significant depth of the outer portion of the UHMWPE, may need to be removed prior to utilizing the UHMWPE in medical device applications.

To help eliminate the free radicals that are formed during irradiation that fail to cross-link and therefore may cause oxidation, the UHMWPE may be melt annealed by heating the crosslinked UHMWPE to a temperature in excess of its melting point. By increasing the temperature of the UHMWPE above its melting point, the mobility of the individual polyethylene molecules significantly increases, facilitating additional crosslinking of the polyethylene molecules and the quenching of free radicals. To heat the UHMWPE above its melting point, the UHMWPE may be placed in a convection oven in ambient air. A convection oven operates by activating a heating element or burner that comes in contact with the ambient air in the oven. By contacting the heating element or burner, the internal energy of the air is increased, causing a corresponding increase in its temperature. The air, in turn, then contacts the UHMWPE and increases the internal energy of the UHMWPE, causing a corresponding increase in the temperature of the UHMWPE.

### SUMMARY

The present invention relates to reducing the concentration of free radicals in crosslinked UHMWPE. In one exemplary embodiment, UHMWPE is exposed to crosslinking radiation and is then heated by thermal radiation. For example, the use of thermal radiation may replace the use of convection to heat the UHMWPE. In convection heating, a heat source, such as a heating element or open flame, is used to increase the temperature of an intermediate medium, such as air or water, that then contacts the object to be heated and transfers thermal energy thereto. As a result, convection heating cannot work in a vacuum. In contrast, thermal radiation does not require an intermediate medium as it utilizes electromagnetic waves that are absorbed by the object to be heated. The absorption of the electromagnetic waves by the object to be heated results in an increase in the thermal energy of the object and, correspondingly, an increase in the temperature of the object.

In one exemplary embodiment, the UHMWPE is exposed to infrared radiation. In this embodiment, the infrared radiation generated may be in the near infrared spectrum, the mid infrared spectrum, or the far infrared spectrum. In particular, the infrared radiation generated may have a wavelength from approximately one micron to fifteen microns. In one exemplary embodiment, the infrared radiation is provided by an infrared heater having a tungsten heating element with a quartz tube. In this embodiment, the infrared radiation may have the wavelength from about 0.50 micron to about 5.0 microns. In another exemplary embodiment, the UHMWPE is compression molded into bars prior to exposure to the crosslinking radiation.

In one exemplary embodiment, once the UHMWPE bars are crosslinked, the UHMWPE bars are hung from a rotating conveyor for exposure to the infrared radiation. In another exemplary embodiment, the UHMWPE bars are placed on a rack for exposure to the infrared radiation. In yet another embodiment, the UHMWPE bars may be placed on a conveyor that travels through an oven having a plurality of infrared heating elements. As the bars travel through the oven, the UHMWPE bars are exposed to the infrared radiation. In order to decrease the heating of the air between the infrared heating element and the UHMWPE bar, a fan may be used to move warm air away from the UHMWPE bar and draw cooler air toward the UHMWPE bar. By keeping the air surrounding the UHMWPE bar at a lower temperature during irradiation, the surrounding air is less reactive, lessening the likelihood of the UHMWPE bar experiencing surface oxidation while annealing. In one exemplary embodiment, a plurality of infrared heating elements and a plurality of fans are arranged to facilitate the desired heating of the UHMWPE bar and also to achieve the desired movement of air surrounding the UHMWPE bar.

Advantageously, by utilizing infrared radiation to melt anneal UHMWPE, oxidation of the exterior surface of the UHMWPE bar is substantially lessened. For example, during traditional melt annealing in a convection oven in ambient air, up to eight millimeters of the UHMWPE bar may be oxidized and, thus, rendered unsuitable for use in medical device applications. In contrast, by infrared melt annealing the UHMWPE bars, two millimeters or less of the UHMWPE bar is oxidized. Advantageously, this results in a substantial cost savings as less of the UHMWPE bar is rendered unsuitable for use in its intended application.

Additionally, infrared melt annealing of the UHMWPE bar results in the UHMWPE bar experiencing homogeneous heating and cooling, at a substantially faster rate than in a convection oven. For example, a conventional melt annealing cycle in a convection oven, which begins with a temperature ramp up, extends through a temperature hold, and ends with a temperature cool down, may be approximately 48 hours. In contrast, the use of infrared radiation to melt anneal a UHMWPE bar may be performed in approximately eight hours or less. This results in a substantial reduction in cycle time, which also provides significant cost savings. Further, the need to utilize a convection oven, which may be large, bulky, and expensive, is obviated.

In one form thereof, the present invention provides a method of processing UHMWPE for medical device applications, the method comprising the steps of: providing a quantity of UHMWPE; crosslinking the UHMWPE; and heating the UHMWPE by exposing the UHMWPE to thermal radiation at a watt density of at least 1 watt per square centimeter.

In another form thereof, the present invention provides a crosslinked UHMWPE for use in medical implants prepared by a process comprising the steps of: providing a quantity of UHMWPE; crosslinking the UHMWPE; and heating the UHMWPE by exposing the UHMWPE to thermal radiation with a watt density of at least 1 watt per square centimeter.

### BRIEF DESCRIPTION OF THE DRAWINGS

The above-mentioned and other features and advantages of this invention, and the manner of attaining them, will become more apparent and the invention itself will be better understood by reference to the following description of an embodiment of the invention taken in conjunction with the accompanying drawings, wherein:

FIG. 1 is a perspective view of an exemplary device for exposing an UHMWPE bar to infrared radiation;

FIG. 2 is a plan view of another exemplary device for exposing an UHMWPE bar to infrared radiation;

FIG. 3 is a plan view of yet another exemplary device for exposing an UHMWPE bar to infrared radiation;

FIG. 4 is a fragmentary, partial cross-sectional, perspective view of the device of FIG. 3;

FIG. 5 is a partial cross-sectional view of an exemplary mechanism for use in conjunction with the device of FIGS. 3 and 4;

FIG. 6 is a frontal view of a UHMWPE bar in conjunction with a device for retaining the UHMWPE bar in position;

FIG. 7 is a cross-sectional view of the device of FIG. 6 taken along line 7-7 of FIG. 6;

FIG. 8 is a schematic view of an apparatus for exposing an UHMWPE bar to infrared radiation according to another exemplary embodiment;

FIG. 9 is an exploded perspective view of another exemplary apparatus for retaining an UHMWPE bar in position;

FIG. 10 is a schematic view of another exemplary apparatus for exposing a plurality of UHMWPE bars to infrared radiation;

FIG. 11 is a frontal view of an exemplary conveyor system for exposing UHMWPE bars to infrared radiation;

FIG. 12 is a cross-sectional view of the device of FIG. 11 taken along line 12-12 of FIG. 11;

FIG. 13 is a perspective view of an exemplary apparatus for exposing an UHMWPE bar to infrared radiation; and

FIG. 14 is a perspective view of another exemplary apparatus for exposing an UHMWPE bar to infrared radiation.

Corresponding reference characters indicate corresponding parts throughout the several views. The exemplifications set out herein illustrate preferred embodiments of the invention and such exemplifications are not to be construed as limiting the scope of the invention in any manner.

### DETAILED DESCRIPTION

In one exemplary embodiment of the present invention, UHMWPE is exposed to crosslinking radiation and then melt annealed by exposure to thermal radiation. In one exemplary embodiment, the UHMWPE is melt annealed by exposure to infrared radiation. While described herein with specific reference to infrared radiation, the present invention may be used in conjunction with any type of thermal radiation, such as microwave radiation or ultraviolet radiation, for example.

Once annealed by exposure to infrared radiation, the UHMWPE may be subjected to additional processing steps, such as packaging and/or sterilization. Any medical grade UHMWPE powder may be utilized in conjunction with the present invention to form a UHMWPE bar or another form of stock material suitable for exposure to crosslinking radiation. For example, GUR1050 and GUR1020 powders, both commercially available from Ticona, having North American headquarters located in Florence, Ky., may be used. In one exemplary embodiment, the UHMWPE powder is blended with an antioxidant. Exemplary methods for creating a UHMWPE/antioxidant blend are disclosed in copending U.S. patent application Ser. No. 12/100,894, entitled AN ANTIOXIDANT STABILIZED CROSSLINKED ULTRA-HIGH MOLECULAR WEIGHT POLYETHYLENE FOR MEDICAL DEVICE APPLICATIONS, filed on Apr. 10, 2008, the entire disclosure of which is expressly incorporated by reference herein. The UHMWPE powder may then be processed by compression molding, net shape molding, injection molding, ram extrusion, or monoblock formation, for example.

In one exemplary embodiment, the UHMWPE is compression molded into the form of a bar. In this embodiment, the UHMWPE bar may be molded to a length of substantially between four feet and five feet. Additionally, the UHMWPE bar may be molded into any desired geometric shape, such that the UHMWPE bar has a substantially round cross-section or a substantially square cross-section, for example. Alternatively, the UHMWPE may be net shape molded so that the UHMWPE has a shape substantially similar to the shape of a final orthopedic component.

In another exemplary embodiment, the UHMWPE may be compression molded into a substrate. In one exemplary embodiment, the substrate may be a highly porous biomaterial useful as a bone substitute and/or cell and tissue receptive material. A highly porous biomaterial may have a porosity as low as 55, 65, or 75 percent or as high as 80, 85, or 90 percent. An example of such a material is produced using Trabecular Metal™ technology generally available from Zimmer, Inc., of Warsaw, Ind. Trabecular Metal™ is a trademark of Zimmer Technology, Inc. Such a material may be formed from a reticulated vitreous carbon foam substrate which is infiltrated and coated with a biocompatible metal, such as tantalum, etc., by a chemical vapor deposition (“CVD”) process in the manner disclosed in detail in U.S. Pat. No. 5,282,861, the entire disclosure of which is expressly incorporated herein by reference. In addition to tantalum, other metals such as niobium, or alloys of tantalum and niobium with one another or with other metals may also be used.

After processing, the UHMWPE may be heated to a temperature below the melting point of the UHMWPE blend to relieve any residual stresses that may have been formed during processing and to provide additional dimensional stability. As used herein, the melting point of the UHMWPE is the melting point as determined by ASTM International F2625-07, Standard Test Method for Measurement of Enthalpy of Fusion, Percent Crystallinity, and Melting Point of Ultra-High-Molecular Weight Polyethylene by Means of Differential Scanning Calorimetry. Heating the UHMWPE to a temperature below the melting point of the UHMWPE creates a more homogenous mixture and increases the final crystallinity. For example, the UHMWPE may be preheated using a convection oven or by exposing the UHMWPE to infrared radiation.

Irrespective of whether or not the UHMWPE is heated to a temperature below the melting point of the UHMWPE to relieve any residual stress, the processed UHMWPE may then by preheated in preparation for receiving crosslinking irradiation. As used herein, “crosslinking irradiation” refers to exposing the consolidated UHMWPE blend to ionizing irradiation to form free radicals which may later combine to form crosslinks. For example, the UHMWPE may be preheated using a convection oven or by exposing the UHMWPE to infrared radiation. In one exemplary embodiment, the processed UHMWPE may be preheated to any temperature between room temperature, approximately 23° C., up to the melting point of the UHMWPE, approximately 140° C. In another exemplary embodiment, the UHMWPE is preheated to a temperature between 60° C. and 130° C. In other exemplary embodiments, the UHMWPE may be heated to a temperature as low as 60° C., 70° C., 80° C., 90° C., or 100° C. or as high as 110° C., 120° C., 130° C., 135° C., 140° C. By preheating the processed UHMWPE before irradiation, the material properties of the resulting irradiated UHMWPE are affected. Exemplary methods of preheating UHMWPE prior to irradiation are disclosed in copending U.S. patent application Ser. No. 12/100,894, which is expressly incorporated by reference herein above. Thus, the material properties for a UHMWPE irradiated at a relatively cold, e.g., approximately 40° C., temperature are substantially different than the material properties for a UHMWPE irradiated at a relatively warm, e.g., approximately 120° C. to approximately 140° C., temperature.

Once the UHMWPE is prepared as desired for crosslinking, the UHMWPE may be exposed to crosslinking irradiation to induce crosslinking of the UHMWPE. The irradiation may be performed in air at atmospheric pressure, in a vacuum chamber at a pressure substantially less then atmospheric pressure, or in an inert environment, i.e., in an argon environment, for example. In one exemplary embodiment, crosslinking is induced by exposing the UHMWPE blend to a total radiation dose between about 25 kGy and 1,000 kGy. The irradiation is, in one exemplary embodiment, electron beam irradiation. In another exemplary embodiment, the irradiation is gamma irradiation. In yet another exemplary embodiment, the crosslinking does not utilize radiation, but instead utilizes silane or other forms of chemical crosslinking.

Once the UHMWPE is irradiated, the UHMWPE may be heated above its melting point, i.e., melt annealed, to decrease the free radical concentration in the UHMWPE. In one exemplary embodiment, the UHMWPE is heated above its melting point by exposing the UHMWPE to infrared radiation. For example, the infrared radiation may be provided to the UHMWPE at a watt density as low as 1.0, 1.5, 2.0, 2.5, 5.0, 10, or 20 watts per square centimeter and as high as 30, 40, 50, 60, 70, 80, or 100 watts per square centimeter. Exemplary calculations of the watt density of an emitter are set forth in Example 1 below.

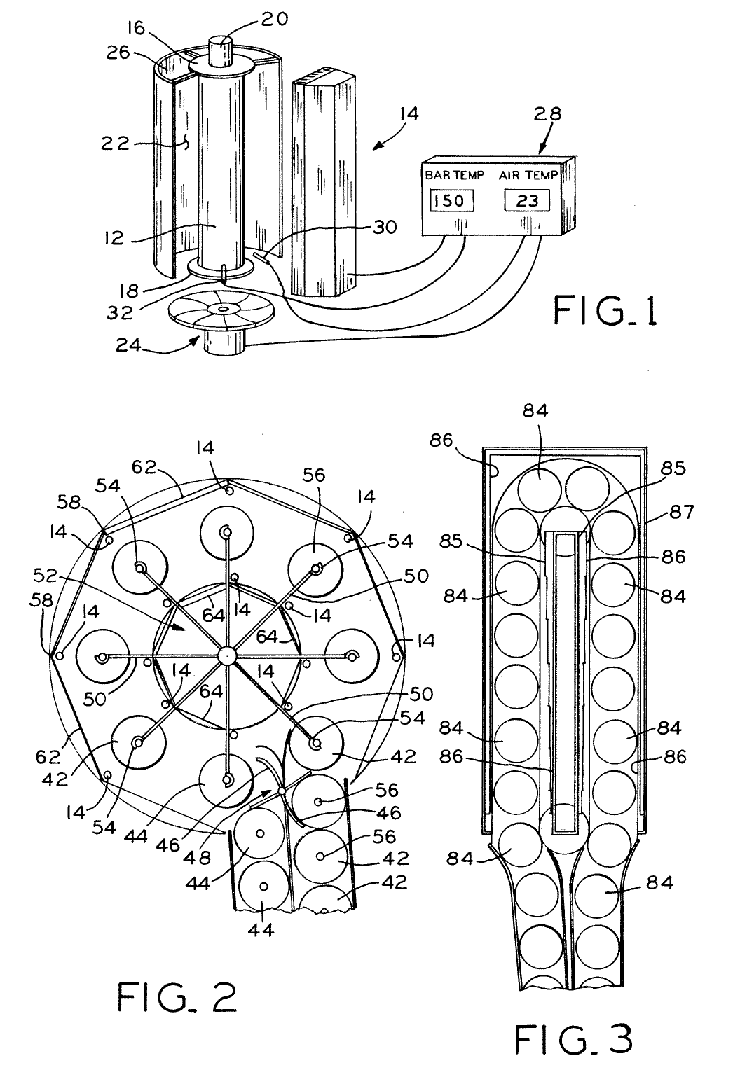

Referring to FIG. 1, an exemplary apparatus 10 is shown for exposing UHMWPE bar 12 to infrared radiation generated by infrared heater 14. In one exemplary embodiment, infrared heater 14 utilizes a tungsten filament positioned within a quartz tube to generate the infrared radiation. While described herein with specific reference to a tungsten filament positioned within a quartz tube, infrared heater 14 may be utilized in conjunction with any filament and/or tube capable of generating infrared radiation. Thus, infrared heater 14 may generate infrared radiation in the near infrared spectrum, the mid infrared spectrum, or the far infrared spectrum. In one exemplary embodiment, infrared radiation having a wavelength measured between adjacent crests of the wave from approximately one micron to fifteen microns is generated. In the embodiment utilizing a tungsten filament and quartz tube, the infrared radiation has a wavelength of substantially between 1.0 microns and 1.5 microns.

Advantageously, infrared melt annealing of the UHMWPE bar results in the UHMWPE bar experiencing homogeneous heating and cooling at a substantially faster rate than in a convection oven. For example, a conventional melt annealing cycle in a convection oven may be approximately 48 hours. In contrast, the use of infrared radiation to melt anneal a UHMWPE bar may be performed in approximately three hours or less. Further, by utilizing infrared radiation, the air or other medium that is surrounding the UHMWPE bar remains at a lower temperature during annealing. As a result, the surrounding air is less reactive, lessening the likelihood of the UHMWPE bar experiencing surface oxidation during annealing.

Referring to FIG. 1, UHMWPE bar 12 is held in place by rotatable plates 16, 18. Rotatable plate 16 is rotated by motor 20 causing corresponding rotation of UHMWPE bar 12 and plate 18, which is freely rotatable about the longitudinal axis of UHMWPE bar 12. At least partially surrounding UHMWPE bar 12 is reflective shielding 22. By altering the amount of reflective shielding 22 surrounding UHMWPE bar 12, as well as the physical properties of reflective shielding 22, the penetration and absorption of infrared radiation by UHMWPE bar 12 may be altered. Fan 24 is positioned below UHMWPE bar 12. Operation of fan 24 draws cool air from the ambient environment and forces the same between UHMWPE bar 12 and reflective shielding 22. This pushes the warmer air upward and out from between the UHMWPE bar 12 and reflective shielding 22 through opening 26 at the top of reflective shielding 22.

Operation of infrared heater 14 and fan 24 may be controlled by temperature controller 28 having thermocouples 30, 32 electronically connected thereto. Thermocouples 30, 32 monitor the temperature of the air surrounding UHMWPE bar 12 and the internal temperature of UHMWPE bar 12, respectively. Based on the readings from thermocouples 30, 32, controller 28 may turn infrared heater 14 on and off in order to reach and maintain a bar temperature in excess of the melting point of the UHMWPE. Similarly, controller 28 may turn fan 24 on and off as needed to ensure that the air temperature around UHMWPE bar 12 remains below a predetermined temperature threshold. For example, in one exemplary embodiment, controller 28 controls the operation of infrared heater 14 so that the temperature of UHMWPE bar 12 is raised to and maintained at substantially 150° Celsius. However, controller 28 may be configured to raise and maintain the temperature of UHMWPE bar 12 at any temperature in excess of the melting point of the UHMWPE. Similarly, in one exemplary embodiment, controller 28 may activate fan 24 when the temperature of the air around UHMWPE bar 12 exceeds 25° Celsius. In another exemplary embodiment, controller 28 activates fan 24 to maintain the air temperature surrounding UHMWPE bar 12 at substantially room temperature, e.g., 23° Celsius.

Referring to FIG. 2, another exemplary embodiment of an apparatus for exposing UHMWPE bars to infrared radiation is depicted as apparatus 40. As shown in FIG. 2, apparatus 40 includes incoming UHMWPE bars 42 that have yet to be subjected to infrared radiation and outgoing UHMWPE bars 44 that have already been subjected to infrared radiation. Specifically, incoming UHMWPE bars 42 are received between opposing arms 46 of spindle 48, which is rotating in a counter-clockwise direction. The counter-clockwise rotation of spindle 48 may be achieved by the use of a motor, such as motor 20 described above, mounted to spindle 48. As spindle 48 rotates, UHMWPE bars 42 are advance until they encounter an open arm 50 of central spindle 52, which is also rotating in a counter-clockwise direction. Similar to spindle 48, the rotation of spindle 52 may be achieved by the use of a motor, such as motor 20 described above, mounted to spindle 52. Thus, as spindle 48 rotates, it advances incoming UHMWPE bar 42 toward an open arm 50 of central spindle 52 where connection portion 54 of an open arm 50 of central spindle 52 engages attachment member 56, as described in detail below.

As central spindle 52 continues to rotate counter-clockwise about centerpoint C, incoming UHMWPE bars 42 are exposed to infrared radiation from infrared heaters 14, positioned at various points throughout the path of central spindle 52. For example, in one exemplary embodiment, infrared heaters 14 are positioned at each corner 58, 60 defined by sections of outer reflective shielding 62 and inner reflective shielding 64, respectively. In another exemplary embodiment, panel heaters may be positioned substantially entirely along portions of outer and inner reflective shielding 62, 64. In one exemplary embodiment, fans 24, shown in FIG. 1, may be positioned above and/or below apparatus 40 to facilitate the transfer of air through apparatus 40 in a substantially similar manner as described in detail above with reference to apparatus 10. Additionally, as described in detail above with specific reference to FIG. 1, a controller, such as controller 28 (FIG. 1), may be used to control the operation of infrared heaters 14 and, if used, fans 24. Additionally, the controller may also be used to control the rate of rotation of spindles 48, 52. Thus, by controlling the rate of rotation of spindles 48, 52, the amount of time that it takes UHMWPE bars 42 to travel through apparatus 40 may be adjusted.

As central spindle 52 continues to travel about centerpoint C in a counter-clockwise direction, UHMWPE bars 42 may also be rotated. For example, connection portions 54 of spindles 50 may also be connected to a motor, such as motor 20 described above, by a combination of shafts and/or gears to cause corresponding rotation of UHMWPE bars 42. In one exemplary embodiment, connection portions 54 are open on one side and rotate 180 degrees for every 45 degrees that center spindle 52 rotates. As a result, the open end of connection portions 54 are aligned with attachment members 56 of UHMWPE bars 42 to allow connection portions 54 to engage attachment members 56 of incoming UHMWPE bars 42 and disengage attachment members 56 of outgoing UHMWPE bars 44. In this manner, UHMWPE bars 42 eventually return to spindle 48 as outgoing UHMWPE bars 44, i.e., UHMWPE bars that have been exposed to infrared radiation, and are received between opposing arms 46 of spindle 48. Specifically, outgoing UHMWPE bars 44 are retained between arms 46 of spindle 48 in a substantially similar manner as incoming UHMWPE bars 42, describe in detail above. As spindle 48 continues to rotate, UHMWPE bars 44 are received by the track where they may be transported to another location and/or apparatus for further processing.

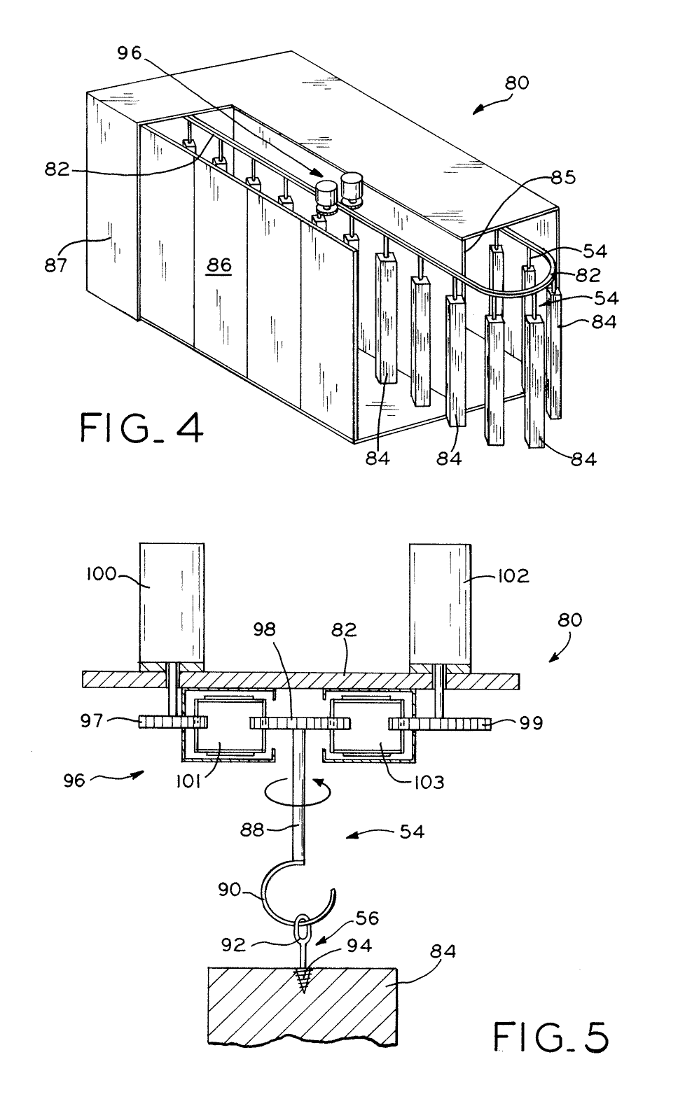

Referring to FIGS. 3-5, another exemplary apparatus for exposing UHMWPE bars to infrared radiation is depicted as apparatus 80. Referring to FIG. 4, apparatus 80 includes conveyor 82 having a plurality of connecting portions 54 configured for connecting to attachment mechanisms 56 (FIG. 5), which are secured to UHMWPE bars 84. Additionally, in one exemplary embodiment, conveyor 80 may further include rotation devices 96, described in detail below with reference to FIG. 5, attached thereto. Apparatus 80 may further include reflective shielding 86 positioned on inner and outer walls 85, 87, respectively, of apparatus 80. As UHMWPE bars 84 travel through apparatus 80 along conveyor 82, they are exposed to infrared radiation from a plurality of infrared heaters 14, shown in FIG. 1. Infrared heaters 14 may be positioned within apparatus 80 in any configuration necessary to achieve the desired heating affects in UHMWPE bars 84 and, as described in detail above with reference to FIG. 1, may be controlled by controller 28. Apparatus 80 may further comprise fans 24, shown in FIG. 1, for regulating the flow of air through apparatus 80. As described in detail above with specific reference to FIG. 1, fans 24 may also be controlled in conjunction with infrared heaters 14 by controller 28. As shown in FIG. 3, UHMWPE bars 84 enter apparatus 80, they travel in a U-shaped pattern between inner wall 85 and outer walls 87. UHMWPE bars 84 then exit apparatus 80 and continue along conveyor 82 for additional processing. Additionally, in one exemplary embodiment, the UHMWPE bars 84 may be placed on conveyor 82 for exposure to crosslinking radiation prior to UHMWPE bars 84 arriving at apparatus 80.

Referring to FIG. 5, an exemplary embodiment of conveyor 82 is shown including connecting portion 54 having elongate shaft 88 with C-shaped hook 90 connected thereto. Connected to UHMWPE bar 84 is attachment member 56 which forms eyelet 92. Eyelet 92 is configured for receipt on C-shaped hooks 90 of connecting portions 54. Attachment member 56 further includes threaded portion 94 extending in a direction opposite of C-shaped hook 90. Threaded portion 94 allows attachment member 56 to be threaded into UHMWPE bar 84. While attachment member 56 and connecting portion 54 are described and depicted herein with specific reference to UHMWPE bars 84 and apparatus 80, attachment member 56 and connecting portion 54 have be used with any UHMWPE bars and/or apparatuses described herein.

As shown in FIG. 5, connecting portion 54, in one exemplary embodiment, is supported by rotation device 96, which is secured to conveyor 82. For example, rotation device 96 may support connecting portion 54 by the securement of connection portion 54 to sprocket 98. In this embodiment, elongate shaft 88 of connecting portion 54 may be welded or otherwise secured to sprocket 98. In one exemplary embodiment of rotation device 96, motors 100, 102 operate to rotate sprockets 97, 99, which correspondingly actuate drive chains 101, 103 in opposite directions. As a result of the movement of drive chains 101, 103, sprocket 98 is rotated to correspondingly rotated connecting portion 54. Alternatively, motors 100, 102 may be variable speed motors that are operated at different speeds. In this embodiment, motors 100, 102 may actuate drive chains 101, 103 in the same direction. Further, in other exemplary embodiments, sprockets 97, 99 may be different sizes. In another exemplary embodiment, only a single motor 100, 102 is used. In this embodiment, one of drive chains 101, 103 may move remain stationary while the other of drive chains 101, 103 is actuated by motor 100, 102.

As a result of the rotation of connection portion 54, attachment member 56 and UHMWPE bar 84 are correspondingly rotated. Thus, operation of rotation device 96 in conjunction with the operation of conveyor 82 results in rotation device 96 providing rotational movement of UHMWPE bar 84 while substantially linear movement of UHMWPE bar 84 is provided by conveyor 82. While rotation device 96 is described and depicted herein with specific reference to conveyor 82, rotation device 96 may also be used in connection with other embodiments of the present invention, such as center spindle 52 of apparatus 40, shown in FIG. 2 and described in detail above.

Advantageously, by utilizing attachment member 56 to secure UHMWPE bars to corresponding apparatuses for exposing the UHMWPE bars to infrared radiation, the UHMWPE bars are allowed to expand as they are subjected to infrared radiation. Specifically, when exposed to infrared radiation and correspondingly heated, the UHMWPE bars undergo thermal expansion. If the thermal expansion of the UHMWPE bars is restricted, the UHMWPE bars may deform from their intended shape, potentially rendering the resulting melt annealed bars unusable. By utilizing attachment member 56, UHMWPE bars 42, 44, 84 are allowed to expand and, when cooled, contract back to their original shape, without any substantial, permanent deformation.

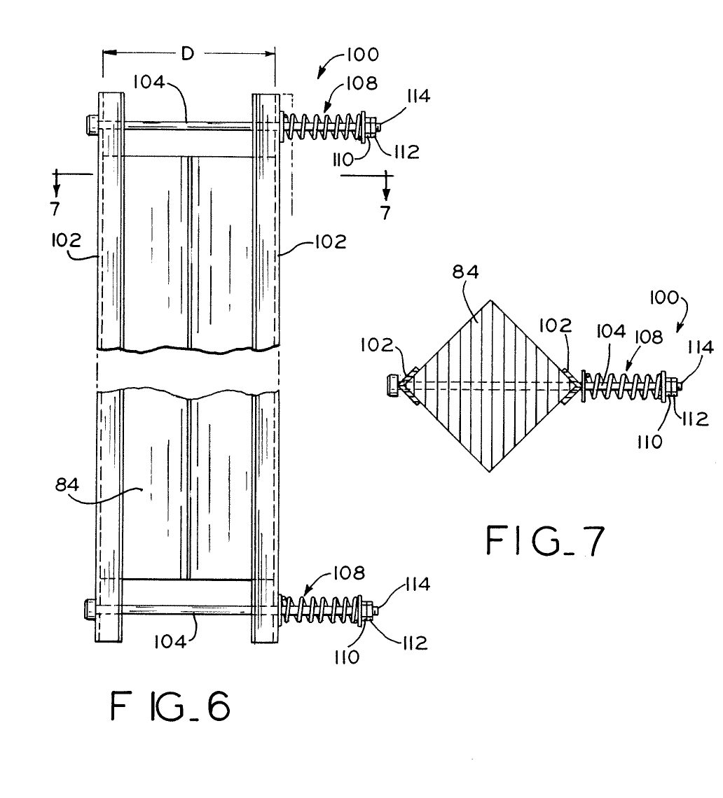

An alternative embodiment of an attachment mechanism for securing UHMWPE bars to the apparatuses described herein is shown in FIGS. 6 and 7 as attachment mechanism 100. As shown in FIGS. 6 and 7, attachment mechanism 100 is secured to UHMWPE bar 84. Specifically, attachment mechanism 100 includes angle braces 102 defining right angles between opposing sides thereof for the receipt of opposing corners of UHMWPE bar 84. Shown in FIG. 6, crossbars 104 are received through apertures (shown in dashed lines) formed in the upper and lower ends of angle braces 102. Crossbars 104 have a length substantially greater than distance D extending between opposing corners of UHMWPE bar 84.

Thus, threaded ends 114 of crossbars 104 are inserted through upper and lower apertures in opposing angle braces 102 until heads 106 of crossbars 104 contact a first one of angle braces 102. Springs 108 are then advanced over opposing, threaded ends 114 of crossbars 104 and positioned thereon. Springs 108 are secured in position on crossbars 104 by washers 110 and nuts 112. Specifically, washers 110 are first positioned on crossbars 104 and then nuts 112 are threadingly engaged with threaded ends 114 of crossbars 104. Nuts 112 may be tightened until springs 108 are slightly compressed between nuts 112 and angle braces 102. Additionally, in one exemplary embodiment, one of crossbars 104 includes an eyelet (not shown) substantially similar to eyelet 92 of attachment member 56. By utilizing an eyelet, attachment mechanism 100 may be connected to connecting portion 54, shown in FIG. 5, is a similar manner as described in detail above with respect to FIG. 5.

Advantageously, by utilizing attachment mechanism 100 to secure UHMWPE bars to corresponding apparatuses for exposing the UHMWPE bars to infrared radiation, the UHMWPE bars are allowed to expand as they are subjected to the infrared radiation. As described in detail above with respect to attachment member 56, UHMWPE bars undergo thermal expansion when heated. Thus, when a UHMWPE bar secured by attachment mechanism 100 begins to expand, the UHMWPE bar forces angle braces 102 against the bias of springs 108, thereby compressing springs 108 against washers 110, which is held in position by nuts 112. By compressing springs 108, the UHMWPE bars may expend while remaining in substantially the same position.

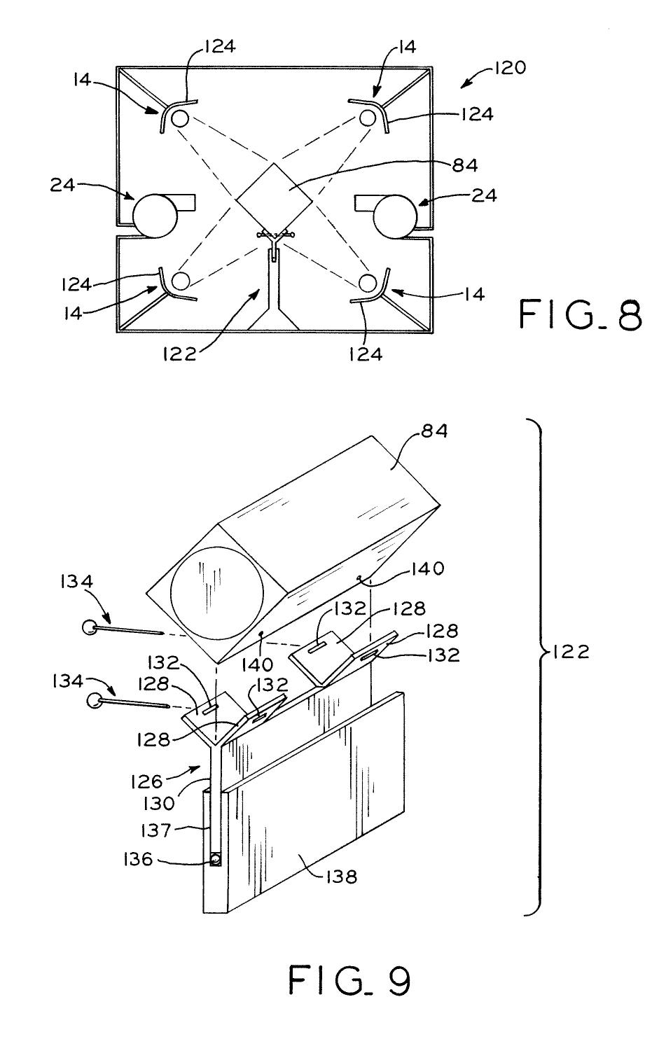

Referring to FIG. 8, another exemplary apparatus for exposing UHMWPE bars to infrared radiation is depicted as apparatus 120. As shown schematically in FIG. 8, apparatus 120 includes attachment mechanism 122, shown in more detail in FIG. 9, which secures UHMWPE bar 84 in position. Positioned adjacent opposing corners of UHMWPE bar 84 are fans 24. In one exemplary embodiment, fans 24 are squirrel-cage fans. Additionally, positioned substantially adjacent each of the opposing sides of UHMWPE bar 84 are infrared heaters 14. To facilitate the reflection of infrared radiation and to encourage the absorption of the same by UHMWPE bar 84, reflectors 124 may be positioned about apparatus 120 in a similar manner as described in detail above with reference to apparatus 10, for example. In one exemplary embodiment, reflectors 124 are arranged to direct the infrared radiation substantially toward the planer surfaces of UHMWPE bar 84. Additionally, as discussed in detail above with specific reference to FIG. 1 and apparatus 10, controller 28 may be utilized to control the operation of fans 24 and infrared heaters 14.

Referring to FIG. 9, attachment mechanism 122 facilitates the insertion and removal of UHMWPE bar 84 from apparatus 120. Specifically, UHMWPE bar 84 is positioned on carrier 126, having arms 128 extending from support 130 at a right angle to one another to form a substantially Y-shaped holder. Apertures 132 extend through arms 128 and are configured to receive pins 134 therethrough. Thus, by positioning a corner of UHMWPE bar 84 adjacent support 130 such that arms 126 extend along opposing sides of UHMWPE bar 84, pins 134 may be inserted through apertures 132 in arms 128 and through UHMWPE bar 84 to secure UHMWPE bar 84 to carrier 126. In one exemplary embodiment, UHMWPE bar 84 is drilled to form apertures 140 therein. Pins 134 may then be received through apertures 132 in arms 128 and apertures 140 in UHMWPE bar 84 to facilitate securement of UHMWPE bar 84 thereto. With UHMWPE bar 84 in this position, as shown in FIG. 8, UHMWPE bar 84 is substantially secured within apparatus 120.

Additionally, as shown in FIG. 9, to facilitate the removal of carrier 126 and UHMWPE bar 84 from apparatus 120, carrier 126 is positioned atop bearings 136 which are retained within channel 137 formed in base 138. Referring to FIG. 8, base 138 is secured within apparatus 120 and, in this position, allows for carrier 126 and UHMWPE bar 84 to be slid atop bearings 136 in channel 137. By sliding carrier 126 into and out of apparatus 120, UHMWPE bar 84 may be more readily accessed for attachment to and removable from carrier 126. In another exemplary embodiment, bearings 136 are replaced by a chain drive that can be indexed to allow for substantially automated movement of carrier 126 into and out of apparatus 120. In another exemplary embodiment, a hydraulic cylinder may be utilized to move carrier 126 into and out of apparatus 120.

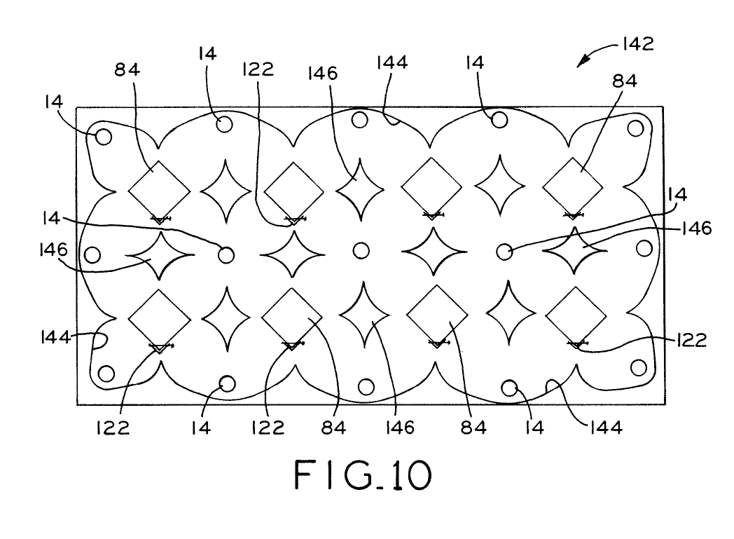

Referring to FIG. 10, another exemplary apparatus for exposing UHMWPE bars to infrared radiation is depicted as apparatus 142. As shown schematically in FIG. 10, apparatus 142 is a larger version of apparatus 120 shown in FIGS. 8 and 9. For example, apparatus 142 includes infrared heaters 14 positioned throughout apparatus 142. Infrared heaters are surrounded by reflective shielding 144 which direct the infrared radiation toward the planar surfaces of UHMWPE bars 84 positioned therein. As shown schematically in FIG. 10, UHMWPE bars 84 are positioned upon attachment mechanisms 122, described in detail above, and secured at various heights throughout apparatus 142. Several infrared heaters 14 are positioned in the center of apparatus 142 and provide infrared radiation to the planar surfaces of several different UHMWPE bars 84. Additionally, positioned between UHMWPE bars 84 is additional reflective shielding 146. In the same manner as reflected in reflective shielding 144, reflective shielding 146 directs infrared radiation toward UHMWPE bars 84. In one exemplary embodiment, reflective shielding 146 has a substantially diamond shaped configuration. Additionally, reflective shielding 146 may also direct cooling air to and exhaust air from the corners of UHMWPE bars 84 to help to decrease the air temperature at the surfaces of UHMWPE bars 84. In this manner, openings (not shown) may be provided within reflective shielding 146. Further, reflective shielding 148 may define a conduit that is connected to fans 24 (FIG. 1) or other devices that facilitate the movement of air through apparatus 142.

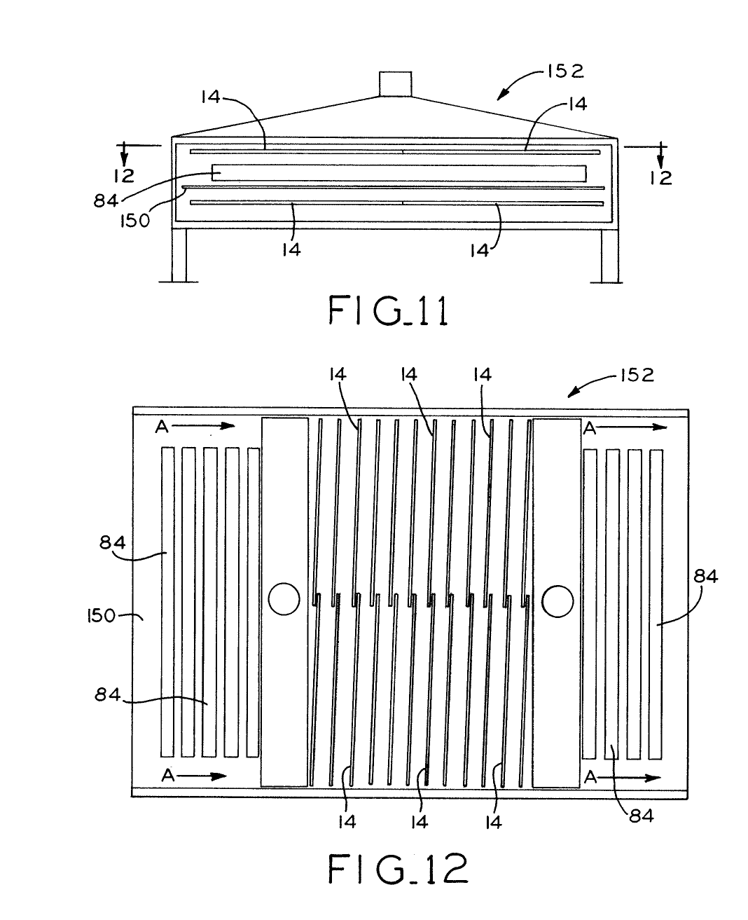

Referring to FIGS. 11 and 12, another exemplary apparatus for exposing UHMWPE bars 84 to infrared radiation is shown as apparatus 152. Apparatus 152 includes conveyor 150 on which UHMWPE bars 84 are positioned. Thus, as conveyor 150 is advanced in the direction of arrows A of FIG. 12, UHMWPE bars 84 travel through oven 154 having a plurality of infrared heaters 14 positioned therein. As the UHMWPE bars travel through oven 154, they are exposed to sufficient infrared radiation to melt anneal UHMWPE bars 84. Additionally, oven 154 may include at least one fan 24 which, in conjunction with heaters 24, may be operated by controller 28, as described in detail above with reference to apparatus 10 of FIG. 1. Once UHMWPE bars 84 exit oven 154 on conveyor 150, UHMWPE bars 84 may continue to additional process stations or may be removed from conveyor 150 for packaging and/or processing.

### EXAMPLES

The following non-limiting Examples illustrate various features and characteristics of the present invention, which is not to be construed as limited thereto. The following abbreviations are used throughout the Examples unless otherwise indicated.

TABLE 1
Abbreviations

| Abbreviation | Full Word |
|---|---|
| kGy | kilo Gray |
| min | minute |
| ° | degrees |
| C | Celsius |
| FTIR | Fourier Transform Infrared Spectroscopy |
| UTS | ultimate tensile strength |
| UHMWPE | ultrahigh molecular weight polyethylene |
| ″ | inches |
| OI | Oxidation Index |
| DSC | Differential Scanning Calorimetry |
| TVI | trans-vinylene index |
| cm | centimeter |
| DMA | dynamic mechanical analyzer |
| Hz | hertz |
| P | net radiated power |
| A | radiating area |
| σ | Stefan's constant |
| e | emissivity (=1 for an ideal radiator) |
| T | temperature of emitter |
| T_{C} | temperature of material |
| c | speed of light |
| λ | wavelength |
| e | base of natural log |
| h | Planck constant |
| k | Boltzman constant |
| E | illuminance |
| I | pointance |
| ND | not detectable |
| μm | micrometer |
| π | 3.14159265 |
| r | distance |
| K | kelvin |
| VF₍₁₋₂₎ | view factor |

### Example 1

### Watt Densities of Thermal Radiation Generated by Different Emitters

Calculations were performed to identify the increased watt density that is generated by using thermal radiation. Specifically, as set forth in TABLE 2 below, the watt density emitted from both the stainless steel walls of a convection oven and a tungsten aged filament from an infrared heater were calculated. The watt density, P, expressed as watts per square centimeter, was calculated using the Stefan-Boltzmann Law, i.e., P=eσA(T⁴−T_{C}⁴), where σ is equal to 5.6703×10⁻⁸ watt/m²K⁴. In performing each of the calculations, a radiating area, A, of one square centimeter was used.

Additionally, the watt density received, i.e., the amount of radiation that reaches a material to be heated, was calculated for different distances between the radiation source and the material to be heated. Specifically, the watt density received at 1 inch, i.e., when 1 inch separates the source of the radiation and the material to be heated, and at 6 inches, i.e., when 6 inches separate the source of the radiation and the material to be heated, were determined by calculating the heat flow at a given distance from the radiation source and multiplying the same by the emissivity coefficient of the material, which is set forth in TABLE 2 below. The heat flow may be calculated using the following equation:

q=56.69×10⁻⁹×VF₍₁₋₂₎×A×(T⁴−T_{C}⁴),

where q is the heat flow, A is the area of the opposing flat surfaces, T is the temperature of the radiation emitter, and T_{C} is the temperature of the material or part to be heated. Additionally, VF₍₁₋₂₎ is the view factor, which at 1 inch is equal to 0.0448244 and at 6 inches is equal to 0.0013666. An area, A, of 1 square centimeter was used in performing each of the calculations.

TABLE 2

| | | | | | Watts/cm² | Watts/cm² |
|---|---|---|---|---|---|---|
| | Emissivity | Emitter | Part | Watts/cm² | received at | received at 6 |
| Emitter | Coefficient | Temp. | Temp. | Emitted | 1 inch | inches |
| Stainless | 0.075 to 0.85 | 423 K | 296 K | 0.010 to 0.117 | 4.64E−04 to 5.26E−03 | 1.42E−05 to 1.60E−04 |
| Steel | | | | | | |
| Tungsten | 0.032 to 0.35 | 2,477 K | 296 K | 6.83 to 74.71 | 0.31 to 3.35 | 0.009 to 0.102 |
| filament | | | | | | |

### Example 2

### Feasibility of Utilizing Infrared Radiation to Melt Anneal Crosslinked UHMWPE

The feasibility of utilizing infrared radiation to melt anneal crosslinked UHMWPE and the mechanical properties of the resulting infrared melt annealed UHMWPE were investigated. To perform this investigation, Design Expert 6.0.10 software, obtained from Stat-Ease, Inc. Minneapolis, Minn., was utilized to create a Design of Experiment (DOE) to evaluate the mechanical properties of the infrared melt annealed crosslinked UHMWPE. The DOE evaluated three different variables: the maximum temperature of the UHMWPE, cooling of the external surface of the UHMWPE, and the amount of time elapsed during temperature ramp up.

Medical grade UHMWPE powder, GUR 1050, was obtained from Ticona, having North American headquarters in Florence, Ky. The UHMWPE was compression molded into approximately 3.5″ square bars. The bar was then cut into sections measuring 6 in length. Each 6″ section was then subjected to electron beam irradiation in air and received a 100 kGy dose. Once irradiated, each 6″ section of UHMWPE bar was immediately packaged in nitrogen where it remained until the time of testing.

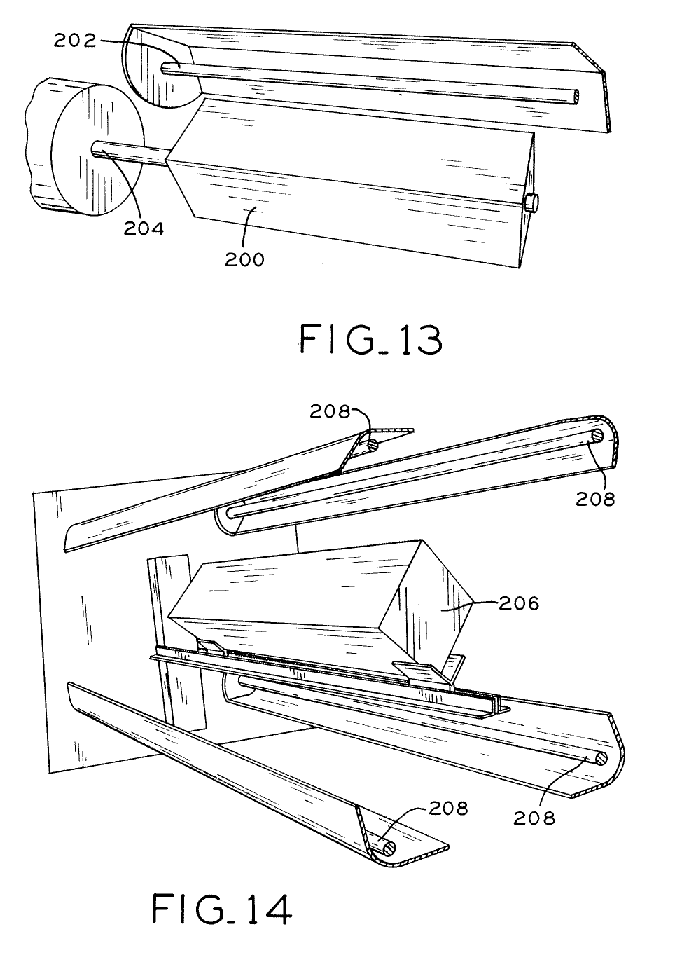

In order to subject the sections of UHMWPE bar to infrared radiation, two Chromalox® T-3 quartz heaters were obtained from Thermtech Systems, Inc. of Chesterfield, Ind. The heaters were positioned 6″ from where a face of a section of the UHMWPE bar is positioned during exposure to the infrared radiation, as shown in FIG. 13. Referring to FIG. 13, an exemplary section of UHMWPE bar 200 and an exemplary infrared heater 202 are shown. Once positioned adjacent the heaters, the section of UHMWPE bar was received on a rotatable bar 204 and rotated using a small motor. The sections were then heated by infrared radiation to a maximum temperature selected from 140° C. and 150° C. and some of the sections were ramped to reach the maximum temperature in four hours, which is identified in TABLE 3 with a “y” in the ramp column. During the heating of some of the sections, as identified in TABLE 3 below, a fan was activated to facilitate cooling of the outer surface of the section of the UHMWPE bar.

A portion of each bar was then microtomed into 2000 micron thick films. These films were then subjected to FTIR analysis on a Bruker Optics FTIR spectrometer, available from Bruker Optics of Billerica, Mass. The FTIR results were analyzed to determine the OI and the TVI. The OI was determined by calculating the ratio of the area under the carbonyl peak on the FTIR chart at 1765-1680 cm⁻¹ to the area of the polyethylene peak at 1392-1330 cm⁻¹. The TVI was determined by calculating the ratio of the area on the FTIR chart under the vinyl peak at 980-947 cm⁻¹ to the area under the polyethylene peak at 1392-1330 cm⁻¹.

Additional testing was then performed to determine the izod impact strength, elongation, UTS, YS, storage modulus, percentage crystallinity, and free radical concentration. The mechanical properties were tested according to corresponding available ASTM standards for UHMWPE. Specifically, Type V tensile specimens, as defined by the American Society for Testing and Materials (ASTM) Standard D638, Standard Test Method for Tensile Properties of Plastics, were machined and subjected to elongation, UTS, and YS testing in accordance with ASTM Standard D638. Izod specimens were also machined and subjected to testing according to ASTM Standard F-648, Standard Test Methods for Ultra-High-Molecular-Weight Polyethylene Power and Fabricated Form for Surgical Implants. The % crystallinity was determined using DSC and measuring the crystallinity between 40° C. and 160° C. Additionally, the storage modulus was measured using a DMA. This method begins by ramping the temperature from room temperature to 150° C. at a rate of 10° C./min and then ramping the temperature from 150° C. to 210° C. at a rate of 2° C./min at 1 Hz. The DMA measurement corresponds to the Storage Modulus of the UHMWPE at 200° C. Additionally, the free radical concentration of the UHMWPE was analyzed using a Bruker EMX/EPR (electron paramagnetic resonance) spectrometer, which has a detection limit of 0.01×10¹⁵ spins/gram and is available from Bruker Optics of Billerica, Mass.

Based on the results of the analysis, the infrared melt annealed crosslinked UHMWPE had OI values lower than the control, which in this case is a convection oven melt annealed crosslinked UHMWPE, and had substantially similar or improved mechanical properties under all of the varying test conditions.

TABLE 3
Mechanical Properties of Infrared Melt
Annealed Crosslinked UHMWPE

| | | | | | Oxidation Index at |
|---|---|---|---|---|---|
| Run | Temp (deg C.) | Fan | Ramp | Material | 2000 microns |
| Control | | — | — | 1050 | 0.0900 |
| 1 | 140 | y | n | 1050 | 0.0234 |
| 2 | 140 | n | n | 1050 | 0.0087 |
| 3 | 140 | y | y | 1050 | 0.0073 |
| 4 | 140 | n | y | 1050 | 0.0289 |
| 5 | 150 | y | y | 1050 | 0.0162 |
| 6 | 150 | n | y | 1050 | 0.0052 |
| 7 | 150 | y | n | 1050 | 0.0007 |
| 8 | 150 | n | n | 1050 | 0.0056 |

| | | | | ESR |
|---|---|---|---|---|
| | | Izod | DMA | (10\hat{ }15 |
| Run | Elongation % | (kJ/m\hat{ }2) | (MPa @ 200 C.) | spins/gram) |
| Control | 231 | 57 | 7.605 | 0.09 |
| 1 | 271 | Not tested | 7.696 | 0.04 |
| 2 | 271 | 69.9 | 7.586 | 0.06 |
| 3 | 279 | 66.9 | 7.433 | 0.02 |
| 4 | 280 | 65.3 | 7.524 | 0.04 |
| 5 | 277 | 66.0 | 7.327 | 0.04 |
| 6 | 261 | 70.3 | 7.428 | 0.05 |
| 7 | 259 | 71.3 | 7.659 | 0.08 |
| 8 | 278 | 71.6 | 7.136 | 0.05 |

### Example 3

### Effects of Varying the Distance of the Infrared Source from the UHMWPE

The optimal distance between an infrared heating element and crosslinked UHMWPE for infrared melt annealing was investigated. To perform this investigation, Design Expert 6.0.10 software, obtained from Stat-Ease, Inc. Minneapolis, Minn., was utilized to create a Design of Experiment (DOE) to evaluate the mechanical properties of the infrared melt annealed crosslinked UHMWPE. The DOE evaluated two different variables: the distance from an infrared heating element to a face of the UHMWPE and the percentage of total heating time that a fan was activated to cool the surface of the bar.

Medical grade UHMWPE powder, GUR 1050, was obtained from Ticona, having North American headquarters in Florence, Ky. The UHMWPE was compression molded into approximately 3.5″ square bars. The bar was then cut into sections measuring 6″ in length. Each 6″ section was then subjected to electron beam irradiation and received a 100 kGy dose. Once irradiated, each 6″ section of UHMWPE bar was immediately packaged in nitrogen where it remained until the time of testing.

In order to subject the sections of UHMWPE bar to infrared radiation, four Chromalox® T-3 quartz heaters were obtained from Thermtech Systems, Inc. of Chesterfield, Ind. The heaters were positioned in the four corners of a square-shaped steel frame. The sections of UHMWPE bar were then removed from their packaging and positioned in a holder that held the sections stationary between the four heaters so that the flat sides of the sections were each directly facing one of the infrared heaters, as shown in FIG. 14. Referring to FIG. 14, an exemplary section of UHMWPE bar 206 and exemplary infrared heaters 208 are shown. The sections were positioned in the frame at a distance from the infrared heaters selected from 5 inches, 7 inches, and 10 inches. Additionally, during the heating of the sections, as identified in TABLE 4 below, a fan was activated to facilitate cooling of the outer surface of the section of the UHMWPE bar for a time selected from 0, 50, and 100 percent of the total heating time. The UHMWPE sections were then allowed to cool.

Testing was then performed to determine the izod impact strength, elongation, UTS, YS, and free radical concentration. The mechanical properties were tested according to ASTM standards corresponding to UHMWPE. Specifically, Type V tensile specimens, as defined by the American Society for Testing and Materials (ASTM) Standard D638, Standard Test Method for Tensile Properties of Plastics, were machined and subjected to elongation, UTS, and YS testing in accordance with ASTM Standard D638. Izod specimens were also machined and subjected to testing according to ASTM Standard F-648, Ultra-High-Molecular-Weight Polyethylene Powder and Fabricated Form for Surgical Implants. Additionally, the free radical concentration was analyzed using a Bruker EMX/EPR (electron paramagnetic resonance) spectrometer, which has a detection limit of 0.01×10¹⁵ spins/gram and is available from Bruker Optics of Billerica, Mass.

Overall, the experiment showed that the UHMWPE had substantially equivalent or better mechanical properties irrespective of heater distance up to 10 inches.

TABLE 4
Effects of Radiation Distance on the Material Properties of
Infrared Melt Annealed Crosslinked UHMWPE

| | Heater Distatnce | | | | | | ESR |
|---|---|---|---|---|---|---|---|
| | From Bar | % of Time | | UTS | YS | Izod | (10\hat{ }15 |
| Sample | (Inches) | Fan Is On | Elongation % | (MPa) | (MPa) | (kJ/m\hat{ }2) | spins/gram) |
| Control | — | — | 231 | 39.4 | 21.03 | 57 | 0.09 |
| 7 | 4 | 0 | 232 | 34.0 | 20.61 | 63.9 | Non Detectable |
| 1 | 4 | 50 | 245 | 33.4 | 20.78 | 60.3 | Non Detectable |
| 11 | 4 | 50 | 224 | 32.8 | 20.67 | 56.2 | Non Detectable |
| 6 | 4 | 100 | 348 | 39.7 | 20.57 | 78.1 | Non Detectable |
| 4 | 7 | 0 | 228 | 32.7 | 20.68 | 59.9 | Non Detectable |
| 9 | 7 | 0 | 316 | 36.9 | 20.24 | 78.0 | Non Detectable |
| 10 | 7 | 50 | 335 | 39.1 | 20.28 | 79.0 | Non Detectable |
| 13 | 7 | 50 | 324 | 36.4 | 20.48 | 78.3 | Non Detectable |
| 3 | 7 | 100 | 301 | 38.0 | 20.66 | 80.2 | Non Detectable |
| 12 | 7 | 100 | 230 | 33.8 | 20.38 | 57.5 | Non Detectable |
| 5 | 10 | 0 | 216 | 35.7 | 20.25 | 58.1 | Non Detectable |
| 8 | 10 | 50 | 225 | 33.0 | 20.49 | 56.1 | Non Detectable |
| 14 | 10 | 50 | 241 | 34.2 | 20.46 | 58.6 | Non Detectable |
| 2 | 10 | 100 | 223 | 32.9 | 20.45 | 59.3 | 2.84 |

### Example 4

### Effects of Different Wavelengths of Infrared Radiation

The effects of using different wavelengths of infrared radiation to infrared melt anneal crosslinked UHMWPE was investigated. Medical grade UHMWPE powder, GUR 1050, was obtained from Ticona, having North American headquarters in Florence, Ky. The UHMWPE was compression molded into approximately 3.5″ square bars. The bar was then cut into sections measuring 6″ in length. Each 6″ section was then subjected to electron beam irradiation and received a 100 kGy dose. Once irradiated, each 6″ section of UHMWPE bar was immediately packaged in nitrogen where it remained until the time of testing.

Three different types of infrared heaters were acquired, as set forth in TABLE 5 below. In order to expose the UHMWPE sections to infrared radiation, two heaters of the same type were positioned approximately 24 inches apart from and facing one another. The heaters were attached to a steel frame and held stationary. The sections of the UHMWPE bar were mounted between the heaters so that the flat sides of the bar were facing the heaters. A thermocouple was mounted inside the sections of the UHMWPE bar to monitor the temperature within the UHMWPE bar. The bar was heated to 150° C. and the time that elapsed until the bar was substantially entirely melted, i.e., the time that elapsed from the initiation of the heating until the opaque crystalline regions of the bar became amorphous and, thus, were optically transparent as determined by visual observation, was recorded. This process was repeated for each type of heater set forth in TABLE 5 below.

TABLE 5
Types of Infrared Heaters Utilized

| | | Manufacturer | |
|---|---|---|---|
| Type of Heater | Manufacturer | Identification | Wavelength |
| Radiant | Watlow | Flat Panel 24″ | Long (8-15 |
| | St. Louis, MO | 2,880 watts/240 V | micrometers) |
| Quartz | | Ramax 1515 25.5″ | Medium (3-8 |
| | | 1,250 watts/240 V | micrometers) |
| Tungsten | | QR16B230 16″ | Short (1.4-3 |
| | | 1,600 watts/240 V | micrometers) |

Once all of the sections of the UHMWPE bar had been tested, the material properties of the resulting sections were analyzed. A portion of each section was microtomed into 2000 micron thick films. These films were then subjected to FTIR analysis on a Bruker Optics FTIR spectrometer, available from Bruker Optics of Billerica, Mass. The FTIR results were analyzed to determine the OI. The OI was determined by calculating the ratio of the area under the carbonyl peak on the FTIR chart at 1765-1680 cm⁻¹ to the area of the polyethylene peak at 1392-1330 cm⁻¹.

Additional testing was then performed to determine the elongation, YS, UTS, and free radical concentration. The mechanical properties were tested according to ASTM standards corresponding to UHMWPE. Specifically, Type V tensile specimens, as defined by the American Society for Testing and Materials (ASTM) Standard D638, Standard Test Method for Tensile Properties of Plastics, were machined and subjected to elongation, UTS, and YS testing in accordance with ASTM Standard D638. Additionally, the free radical concentration was analyzed using a Bruker EMX/EPR (electron paramagnetic resonance) spectrometer, which has a detection limit of 0.01×10¹⁵ spins/gram and is available from Bruker Optics of Billerica, Mass.

The analysis, the results of which are set forth below in TABLE 6, showed that the material properties did not vary substantially between wavelengths. However, the polyethylene appeared most quickly to absorb the short wavelengths, i.e., those generated by the heaters with tungsten filaments.

TABLE 6
Effects of Radiation Wavelength on the Mechanical Properties
of Infrared Irradiated Crosslinked UHMWPE

| | Oxidation | | | | ESR | |
|---|---|---|---|---|---|---|
| | Index at 2000 | | UTS | YS | (10\hat{ }15 | Time to Melt (Hours) |
| | microns | Elongation % | (MPa) | (MPa) | spins/gram) | (3.6 × 3.6 × 6″ bar) |
| Control | 0.0900 | 231.4 | 39.40 | 21.03 | 0.09 | 8 |
| (convection | | | | | | |
| oven) | | | | | | |
| Radiant | 0.0322 | 277.1 | 46.89 | 20.07 | ND | 3.5 |
| Quartz | 0.0340 | 292.3 | 46.51 | 19.44 | ND | 2 |
| Tungsten | 0.0056 | 278.4 | 46.12 | 19.57 | 0.05 | 1.25 |

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of processing UHMWPE for medical device applications, the method comprising the steps of:
providing a quantity of UHMWPE;
crosslinking the UHMWPE; and
heating the UHMWPE by exposing the UHMWPE to thermal radiation at a watt density of at least 1 watt per square centimeter.

2. The method of claim 1, wherein the thermal radiation comprises infrared radiation.

3. The method of claim 1, wherein the heating step further comprises heating the UHMWPE above a melting point of the UHMWPE to melt anneal the UHMWPE, wherein the melting point is determined by differential scanning calorimetry.

4. The method of claim 1, wherein the heating step further comprises heating the UHMWPE above 140 degrees Celsius.

5. The method of claim 1, wherein the infrared radiation comprises a wavelength of substantially between 1.0 microns and 15 microns.

6. The method of claim 5, wherein the infrared radiation comprises a wavelength of substantially between 1.0 microns and 1.5 microns.

7. The method of claim 1, wherein the crosslinking step further comprises exposing the UHMWPE to crosslinking irradiation.

8. The method of claim 7, wherein the crosslinking step further comprises exposing the UHMWPE to electron beam irradiation.

9. The method of claim 1, further comprising the step of compression molding the UHMWPE.

10. The method of claim 1, further comprising, before the crosslinking step, the step of preheating the UHMWPE.

11. The method of claim 10, wherein the preheating step further comprises preheating the UHMWPE using infrared radiation.

12. The method of claim 1, further comprising the step of machining the UHMWPE to form a medical device.

13. The method of claim 1, wherein the heating step further comprises heating the UHMWPE in air.

14. A crosslinked UHMWPE for use in medical implants prepared by a process comprising the steps of:
providing a quantity of UHMWPE;
crosslinking the UHMWPE; and
heating the UHMWPE by exposing the UHMWPE to thermal radiation at a watt density of at least 1 watt per square centimeter.

15. The crosslinked UHMWPE of claim 14, wherein the UHMWPE has an ultimate tensile strength of at least 32 megapascal.

16. The crosslinked UHMWPE of claim 14, wherein the UHMWPE has an izod impact strength of at least 55 kilojoules per square meter.

17. The crosslinked UHMWPE of claim 14, wherein the UHMWPE has a yield strength of at least 20 megapascals.

18. The crosslinked UHMWPE of claim 14, wherein the UHMWPE has an electron spin resonance below 0.10×10¹⁵ spins per gram.

19. The crosslinked UHMWPE of claim 14, wherein the UHMWPE has an ultimate tensile strength of at least 32 megapascal, an izod impact strength of at least 55 kilojoules per square meter, and an elongation of at least 200 percent.

20. The crosslinked UHMWPE of claim 14, wherein the UHMWPE has a yield strength of at least 20 megapascals, a storage modulus of at least 6.0 megapascals at two hundred degrees Celsius, and an electron spin resonance below 0.10×10¹⁵ spins per gram.

21. The crosslinked UHMWPE of claim 14, wherein the heating step of the processes further comprises, heating the UHMWPE in air by exposing the UHMWPE to thermal radiation at a watt density of at least 1 watt per square centimeter.
